(19) United States
(12) Patent Application Publication
(10) Pub. No.: US 2025/0206647 A1
(43) Pub. Date: Jun. 26, 2025

(54) METHODS AND SYSTEMS FOR TREATING COMMERCIAL WASTEWATER AND/OR SLUDGE

(71) Applicant: Alden Group Renewable Energy, The Woodlands, TX (US)

(72) Inventor: William Paul, Bucyrus, KS (US)

(73) Assignee: Alden Group Renewable Energy, The Woodlands, TX (US)

(21) Appl. No.: 18/991,328

(22) Filed: Dec. 20, 2024

Related U.S. Application Data
(60) Provisional application No. 63/614,520, filed on Dec. 22, 2023.

(51) Int. Cl. C02F 9/00; B01D 21/00; B01D 21/01; B01D 21/26; B01D 21/28; C02F 1/00; C02F 1/02; C02F 1/24; C02F 1/38; C02F 1/52; C02F 1/68; C02F 101/32

(52) U.S. Cl. CPC C02F 9/00; B01D 21/0012; B01D 21/01; B01D 21/262; B01D 21/283; C02F 1/004; C02F 1/02; C02F 1/24; C02F 1/385; C02F 1/52; C02F 1/68; C02F 2101/32; C02F 2301/08; C02F 2303/18

(57) ABSTRACT

Methods and systems for treating and/or purifying commercial wastewater and/or commercial wastewater sludge for introduction directly into public sewer system including pretreating with a bentonite composition.

### BACKGROUND

### Technical Field

The present disclosure is directed to methods and systems configured for treating and/or purifying commercial wastewater for introduction directly into public sewer systems.

### Related Art

Excessive concentrations of polar FOG (fats, oils, and/or greases) and polar brown FOG, i.e., polar FOG contaminated with solids commonly found in commercial food preparation, grease traps, interceptors, and/or any material associated therewith, are a major problem in commercial wastewater collection and/or public treatment systems. Polar FOG (including polar brown FOG hereinafter) typically originates from animals or vegetable (foods). Because of the prevalence of food service, commercial food frying, and commercial food processing enterprises in populated areas, polar FOG is responsible for a large percentage of sewer system failures and overflows. In particular, polar FOG, if not intercepted, congeals on, and sticks to piping and fixtures in wastewater systems, and, as well, to other debris flowing in the waste stream creating plugs and causing functional failures of the sewer system components.

Publicly owned sewage treatment systems and local governments associated therewith, often attempt to regulate, via statue and/or regulation, the discharge of commercial wastewater including polar FOG into public systems, and some have mandated the use of grease traps and/or interceptors to prevent/limit the introduction of commercial wastewater including polar FOG into such treatment systems. However, grease traps and interceptors have limited capacities and any accumulated polar FOG contained therein requires proper disposal performed typically by professional polar FOG haulers.

Properly disposing of commercial wastewater including polar FOG, and particularly polar brown FOG from commercial frying, grease traps and/or interceptors, is historically difficult, costly, and generally environmentally unfriendly for many reasons. Some reasons includes, but are not limited to, polar brown FOG being considered hazardous to handle, as well as the disposal thereof being limited to outside public sewers systems. More particularly for land application, the disposal of polar brown FOG may be restricted to landfills isolated from known aquifers and/or water supplies. Thus there remains a need for new methods and/or systems suitable for processing commercial wastewater and/or sludge including polar FOG materials in a manner suitable for introduction into public sewer systems and away from land applications, such as landfills.

### SUMMARY

The present disclosure provides methods and systems configured to perform such methods suitable for treating and/or purifying commercial wastewater and/or sludge including at least some portion of polar FOG, and particularly at least polar oils or polar brown oils, for the production of effluent water, i.e., water of sufficient treatment for the proper disposal of and/or introduction directly into public water systems.

For brevity purposes, the use of the terms commercial wastewater, wastewater, wastewater sludge, commercial wastewater sludge, and/or sludge may be interchangeable throughout the present application. For example, the methods (or systems) for treating and/or purifying commercial wastewater described herein may also be described as methods of treating and/or purifying wastewater, wastewater sludge, commercial wastewater sludge, or sludge.

The present disclosure also provides polar oil and/or polar FOG treating and/or purifying methods and/or systems including the addition of a bentonite composition (e.g., a sodium bentonite slurry) into a commercial wastewater prior to a three-phase separation process/device resulting in a water-based stream (i.e., stick or centrate water) that can be further treated for proper disposal. Without the addition of the bentonite composition (e.g., sodium bentonite slurry) as a pretreatment of the wastewater and/or sludge prior to the three-phase-separation, the resultant water-based stream (i.e., stick or centrate water) is unable to be further processed and/or cleaned (e.g., via additional separation and/or flocculation process) for proper discharge into public waters Without the pretreatment with the bentonite composition (e.g., sodium bentonite slurry), the resultant water-based stream (i.e., stick or centrate water) will not further chemically treat as a result of the residual chemicals remaining from the sludge generation and the emulsification effect of the water and solids within three-phase-separation device.

The present disclosure provides methods of treating commercial wastewater containing polar oils including the one or more of the following steps: pretreating an amount of commercial wastewater with a bentonite composition in one or more final heat tanks yielding a pretreated wastewater; separating the pretreated wastewater, via a first centrifugal separator, into at least an oil-based stream and a first water-based stream; flocculating the first water-based stream yielding a flocculated first water-based stream; separating at least flocculent, via a second centrifugal separator, from the flocculated first water-based stream yielding a second water-based stream; flocculating the second water-based stream yielding a flocculated second water-based stream; separating at least flocculent, via a floatation separator, from the flocculated second water-based stream yielding a third water-based stream of sufficient treatment configured to be discharged directly to a public sewage treatment plant (POTW).

In some embodiments, the methods of treating commercial wastewater may further include a prescreening step wherein the commercial wastewater is prescreened prior to being pretreated. In some embodiments, the prescreening may involve passing the commercial wastewater through one or more of a debris screening configured to remove large solids greater than about 0.25 inches, a classifying shaker screen configured to remove small solids less than about 0.25 inches, or both.

In some embodiments, the methods of treating commercial wastewater may further include a step of steaming wherein steam is added to the commercial wastewater prior to prescreening.

In some embodiments, the methods of treating commercial wastewater may further include a step of preheating the commercial wastewater in one or more preheat tanks prior to pretreating yielding a preheated wastewater. In some embodiments, the preheated wastewater is preheated to a first temperature ranging from about 50° C. to about 60° C. In some embodiments, a viscosity of the preheated wastewater ranges from about 80 cP to about 90 cP.

In some embodiments, the methods of treating commercial wastewater may further include one or more steps of: agitating the commercial wastewater during preheating inside at least one of the one or more preheat tanks; agitating the commercial wastewater during pretreating inside the one or more final heat tanks, or both.

In some embodiments, the preheated wastewater is heated to an optimal pretreating temperature ranging from about 80° C. and about 90° C. prior to pretreating in the one or more final heat tanks.

In some embodiments, an optimal pretreating viscosity of the preheated wastewater ranges from 80 cP to 90 cP prior to pretreating in the one or more final heat tanks.

In some embodiments, the bentonite composition used in one or more of the methods described herein includes sodium bentonite and/or is a sodium bentonite slurry. The sodium bentonite may represent from about 0.01% to about 5% by weight of the bentonite composition or bentonite slurry. In some embodiments, the sodium bentonite represents from about 0.1% to about 0.4% by weight of the bentonite composition or bentonite slurry.

In some embodiments, the preheated wastewater is pretreated with about 1% to about 20% bentonite composition or bentonite slurry by volume. In some embodiments, the preheated wastewater is pretreated with about 8% to about 12% bentonite composition or bentonite slurry by volume.

The first centrifugal separator of the methods described herein may include one or more tricanters and the second centrifugal separator may include one or more decanters. The floatation separator may include a DAF unit.

In some embodiments, the oil-based stream of the methods of treating commercial wastewater described herein is separately collected in one or more ISO tanks.

Systems for treating commercial wastewater are also described. The systems may include one or more of the following: a prescreening apparatus; a preheating tank configured to receive and preheat an amount of the commercial wastewater therein to yield a preheated wastewater; a final heating tank configured to receive and heat the preheated wastewater and mix the preheated wastewater with a bentonite composition thereinto yield a pretreated wastewater containing bentonite; a first centrifugal separator configured to separate the pretreated wastewater into a first water-based stream, an oil-based stream, and a solid stream; a first flocculator configured to flocculate the first water-based stream to yield a flocculated first water-based stream; a second centrifugal separator configured to separate the flocculated first water-based stream to yield a second water-based stream; a second flocculator configured to flocculate the second water-based stream to yield a flocculated second water-based stream, and/or a floatation separator configured to separate the second water-based stream to yield a third water-based stream of sufficient treatment for discharge directly to a public sewage treatment plant (POTW).

### BRIEF DESCRIPTION OF THE DRAWINGS

FIG. 1 is a schematic illustration of at least one method and/or system for treating and/or purifying commercial wastewater sludges as described in one or more embodiments herein, and

FIG. 2 is a schematic illustration of at least one method and/or system of treating and/or purifying commercial wastewater as described in one or more embodiments herein.

### DETAILED DESCRIPTION

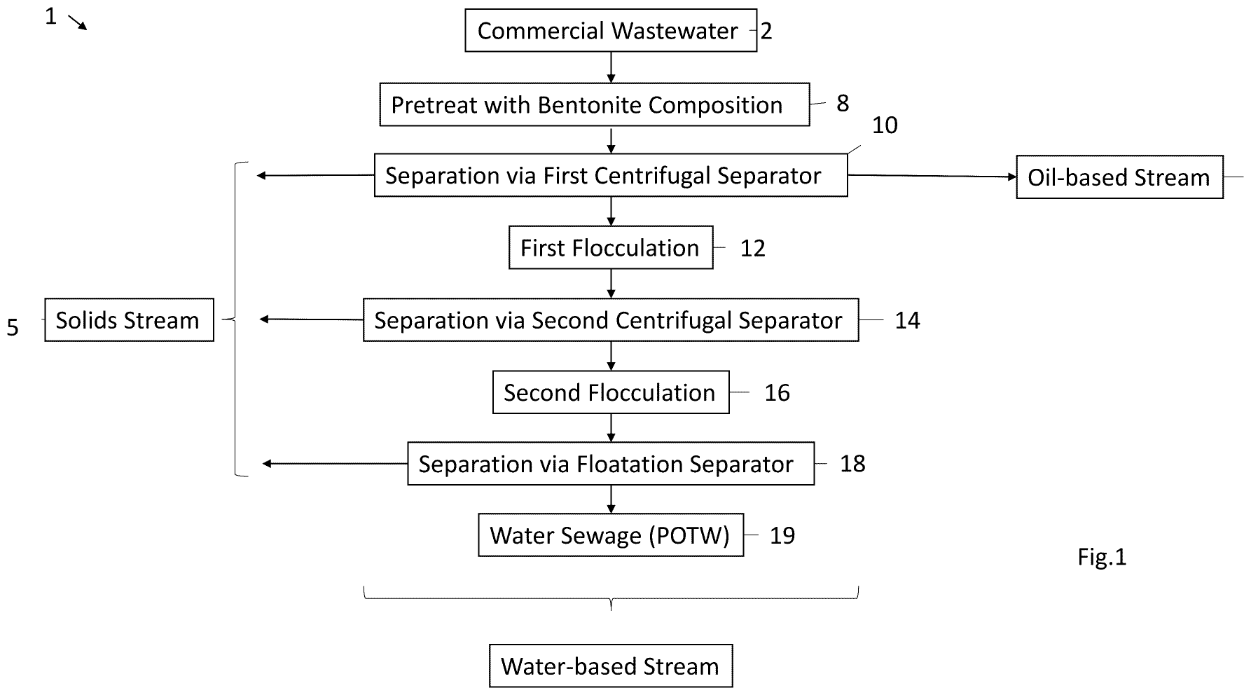

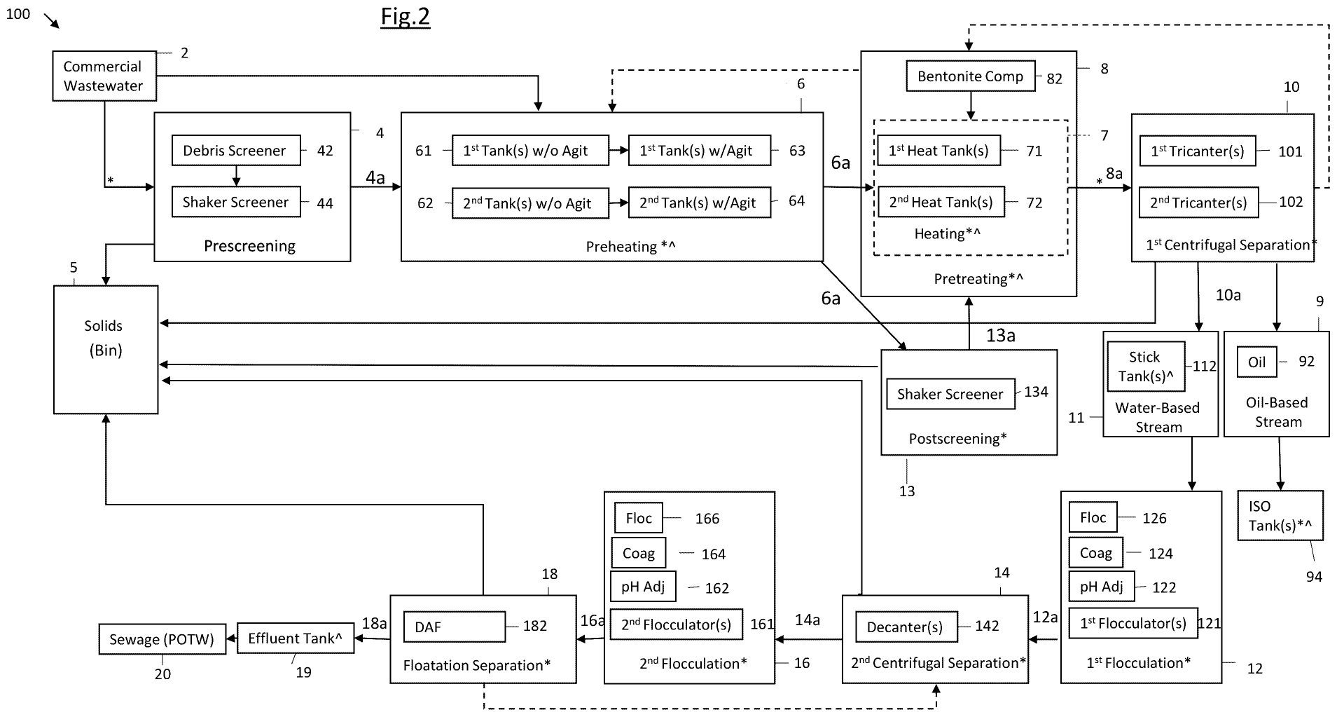

As shown in FIGS. 1 and 2, methods and/or systems 1, 100 configured to treat and/or purify (hereinafter, for brevity, simply treat, treating, treated) commercial wastewater are described herein. Commercial wastewater as used herein includes at least polar oils and/or any combination of polar FOG materials (i.e., fats, oils, and/or grease) including polar oils, as well as possible contaminants (e.g., sewage, dirt, rocks, metals, debris). In some embodiments, the commercial wastewater includes at least polar oils, and particularly polar oils of any known color (e.g., brown, yellow, black, etc.).

The methods and/or systems 1, 100 described herein are designed to separate commercial wastewater into solids (recyclable and/or non-recyclable), recyclable oils, and effluent water. The recyclable oils may be suitable for use in the production of renewable diesel or biodiesel fuel. The effluent water being sufficiently treated for introduction directly into public water systems (e.g., sewer systems, public water treatment plants, etc.). The solids may be recyclable (e.g., plastics, paper, etc.) or non-recyclable, the non-recyclable being shipped to landfills or additional processing facilities.

As further shown in FIGS. 1 and 2, the methods and/or systems 1, 100 described herein may be configured to treat commercial wastewater using only a single pretreatment with a bentonite composition prior to multiple separation processes to yield wastewater of sufficient purity (e.g., generally free of at least polar oils, if not all polar FOG materials, and any contaminants associated therewith) for introduction directly into public water systems. In some embodiments, the wastewater yielded from the methods and/or systems described herein may include a biochemical oxygen demand below 10,000 mg/L and/or a total suspended solids amount below 200 mg/L for introduction directly into public water systems.

As depicted particularly in at least FIG. 1, the methods (and/or systems) 1 described herein for treating commercial wastewater may include one or more of the following: receipt of commercial wastewater 2; pretreatment of the commercial wastewater with a bentonite composition 8 yielding pretreated commercial wastewater 8a: a first separation via a first centrifugal separator 10 of the pretreated commercial wastewater 8a into a solids stream 5, an oil-based stream 9, and a first water-based stream 11; a first flocculation 12 of the first water-based stream 11 yielding a flocculated first water-based stream 12a; a second separation via a second centrifugal separator 14 of at least a first flocculent of the flocculated first water-based stream 12a yielding a second water-based stream 14a; a second flocculation 16 of the second water-based stream 14a yielding a flocculated second water-based stream 16a; and a third separation via a floatation separator 18 of at least a second flocculent of the flocculated second water-based stream 16a yielding a third water-based stream 18a. The third water-based stream 18a being an effluent water of sufficient treatment or purity configured to be discharged directly to a public water system 20, particularly a public water sewage system, without damaging, clogging, and/or polluting the public system 20. The oil-based stream 9 may be separated for collection. The solids stream 5 may be separated for collection throughout various steps or components of the methods and/or systems described herein.

The pretreatment step with a bentonite composition is described in more detail below. The pretreatment with a bentonite composition is designed to ensure the pretreated wastewater 8a and/or the first and second water-based streams 10a, 14a, maintain a sufficient amount of the bentonite composition to allow for at least two separation steps, and more particularly, at least two separation steps and two flocculation steps. A concentration of the bentonite composition within the wastewater 8a may decrease after each separation step, while maintaining a sufficient concentration of the bentonite composition to allow for one or more additional separation steps.

In some embodiments, the first centrifugal separator may be one or more tricanters. In some embodiments, the second centrifugal separator may be one or more decanters. In some embodiments, the floatation separator may be a Dissolved Air Flotation (DAF) Separator. In some embodiments, the first and second flocculent may be the same material. In some embodiments, the first and second flocculent may be different materials.

As depicted particularly in at least FIG. 2, the methods and/or systems 100 for treating and/or purifying commercial wastewater may include one or more of the following: receiving and/or analyzing of an amount of commercial wastewater 2; prescreening 4 of the commercial wastewater 2; preheating 6 of the commercial wastewater 2 (e.g., prescreened 4a and/or not prescreened 2) yielding a preheated wastewater 6a; post-screening 13 of the preheated commercial wastewater 6a yielding a post-screened, preheated wastewater 13a; pretreating 8 of the preheated commercial wastewater 6a (and/or the post-screened, preheated wastewater 13a) yielding a pretreated commercial wastewater 8a; separating of the pretreated wastewater 8a via a first centrifugal separation process 10 into a solid stream 5, a first water-based stream 11, and an oil-based stream 9; flocculating 12 the first water-based stream 11 yielding a flocculated first water-based stream 12a; separating at least one or more flocculents of the flocculated first water-based stream 12a via a second centrifugal separation process 14 yielding a second water-based stream 14a; flocculating 16 the second water-based stream 14a yielding a flocculated second water-based stream 16a; and, separating at least one or more flocculents of the flocculated second water-based stream 16a yielding a third water-based stream 18a (i.e., effluent water) of sufficient purity and/or treatment configured to be discharged to a sewage treatment plant (POTW), a drain or leach field, and the like.

It is envisioned that the methods and/or systems described herein can be utilized and/or operated on any size scale, i.e., small scale, large scale, or any scale therebetween. For example, in some embodiments, the methods and/or systems described herein can be utilized and/or operated on a large scale (e.g., >50,000 gallons/day) as a separate, free-standing treatment facility wherein commercial wastewater is transported thereto, such as via tanker truck or train car. Alternatively, in some embodiments, the methods and/or systems described herein may be designed to be utilized and/or operated on a smaller scale (e.g., <50,000 gallons/day) directly on-site of a facility, such as a food processing facility and/or food production facility, wherein a byproduct produced is commercial wastewater.

The commercial wastewater 2 as described herein may be processed in any suitable amount and from any suitable source. For example, in some embodiments, the commercial wastewater sludge may be provided by the truckload or trainload. In some embodiments, the amount of wastewater provided may range from tens of gallons (i.e., 10, 20, 30, etc.) to hundreds of gallons (i.e., 100, 200 300, etc.) to thousands of gallons (i.e., 1,000, 2,000, 3,000, etc.) to tens of thousands of gallons (i.e., 10000, 20000, 30000, etc.), and so on.

Upon receipt of the commercial wastewater 2, an analysis of the wastewater 2 may be performed to determine the most efficient treatment or purification process using the methods and/or systems described herein. The analysis may include a physical analysis, a chemical analysis, or both. For example, in some embodiments, a physical review of the wastewater 2 may be performed to estimate debris content, solids content, oil content, odor level, and/or general viscosity of the wastewater 2. In another example, in some embodiments, a chemical review may be performed to estimate the chemical make-up of the wastewater 2 (i.e., percentage of polar oils, water, and/or solids).

In some embodiments, a laboratory (onsite or otherwise) may analyze the commercial wastewater to verify quality and establish the process parameters during pretreatment. Contaminants, including but not limited to, MIUs (moisture, insolubles, and unsaponifiables) may also be removed via the methods and/or systems described herein to meet the quality specifications suitable for introduction into public water systems.

In some embodiments, the analysis may result in the commercial wastewater 2 being given a grade such as, but not limited to, a high yield wastewater representing a commercial wastewater having greater than about 10% oil in the wastewater or sludge or a low yield representing a commercial wastewater having less than about 3% oil, such as wastewater commonly derived from grease traps and/or interceptors. In some embodiments, the various grades may be separated and treated separately using different parameters, such as temperature, agitation, viscosity, and/or bentonite concentration. In some embodiments, the various grades may be combined and treated collectively using the same parameters, such as temperature, agitation, viscosity, and/or bentonite concentration.

As shown in FIG. 2, in some embodiments, the commercial wastewater 2 may go through a prescreening 4, a preheating 6, or both, before being pretreated 8 with a bentonite composition. Prescreening 4 is designed to remove contaminants and/or debris in the wastewater 2 that might interfere with the methods and/or systems described herein, and particularly, the pretreatment 8 processes described herein. For example, in some embodiments, the wastewater 2 may be prescreened by being passed through an inlet screen, such as a static debris screen 42, an inlet shaker screen 44, or both, yielding a prescreened wastewater 4a. The static debris screen 42 may be configured to remove large solids (e.g., contaminants/debris) greater than about 0.25 inches, such as straws, plastic utensils, gloves, cups, rocks, bones, and the like, from the wastewater 2. The inlet shaker screen 44 may be configured to remove solids less than about 0.25 inches, such as pieces of food, dirt, flour, breading, plastics, bones, or metals sufficiently small enough to be suspended in the wastewater 2. The solids removed from the wastewater 2 via prescreening 4 can be collected at solids bin 5 for further processing or disposal off-site.

In some embodiments, the wastewater 2 may be of such high yield and generally free of contaminants and/or solid debris that no prescreening is necessary and the wastewater may proceed directly to the step of preheating 6. In some embodiments, the wastewater 2 may be of such low yield and including physically visible solids, such as wastewater 2 derived from grease traps, that one or more prescreening steps is necessary before proceeding to the step of preheating 6 and/or any steps thereafter. Removal of at least a majority, if not all, of solids, and particularly visible solids, aids in obtaining a proper pretreatment temperature and/or pretreatment viscosity of the wastewater 2 prior to the pretreatment 8 with a bentonite composition.

Preheating 6 may be designed to liquify any solidified FOG materials, including particularly fatty acids (e.g., saturated and/or unsaturated fatty acids). Preheating 6 may also separate out the oil from water within the wastewater 2 (and/or prescreened wastewater 4a). Preheating 6 is intended to equalize a stream flow of the wastewater 2 (and/or prescreened wastewater 4a) to make transport of the wastewater 2 (and/or prescreened wastewater 4a) more efficient throughout the system and/or methods 100. For example, in some embodiments, wastewater 2 (and/or prescreened wastewater 4a) may be preheated 6 in one more tanks without agitation 61, 63, and/or one or more tanks with agitation 62, 64 yielding a preheated wastewater 6a. The preheated wastewater 6a being of sufficient temperature and/or viscosity as to be easily pumped and/or transported from the one or more preheat tanks 61-64 to one or more final heat tanks 71, 72.

In some embodiments, a preheat tank without agitation 61, 63 is not connected to a heating source and may be designed simply as an overflow tank for aiding in maintaining a proper pressure and/or equal stream flow of the wastewater 2 (and/or prescreened wastewater 4a) immediately prior to preheating 6.

A tank with agitation 62, 64 is connected to a heating source or system (as indicated by the “*” throughout FIG. 2) and is designed to maintain the wastewater 2 (and/or prescreened wastewater 4a) at a proper preheated temperature, a proper preheated viscosity, or both. Any suitable heating source may be utilized to maintain the proper preheating temperature and/or viscosity, and in particular embodiments may be steam and/or steam generated.

In some embodiments, the methods and/or systems 1, 100 described herein may include a first and second set of tanks 61, 63 without agitation and a first and second set of tanks with agitation 62, 64 for performing the preheating steps 6. In some embodiments, the methods and/or systems may include twice as many tanks with agitation 62, 64 as tanks without agitation 61, 63.

Any suitable agitation source may be utilized to agitate the wastewater 2 (and/or prescreened wastewater 4a) during preheating 6. Care should be given as to not emulsify the FOG into the water or sludge and only to stir the solution when mixing and not to sheer.

In some embodiments, the agitator may be one or more rotary blades or rotary fan located inside the tank. The agitator may be designed to be submersible in the wastewater 2 (and/or prescreened wastewater 4a). In some embodiments, the blades or fans may be positioned parallel to a width or horizontal of the tank 61-64. In some embodiments, the blades or fan may be positioned parallel to a length or height of the tank 61-64.

A proper preheating temperature and preheating viscosity of the wastewater 2 (and/or prescreened wastewater 4a) will vary depending upon the particular constituents (e.g., saturated or unsaturated fatty acids, polar oils, grease, contaminants, etc.) of the wastewater 2 (and/or prescreened wastewater 4a). In some embodiments, a proper preheating temperature may range from about 25° C. to about 100° C. In some embodiments, a proper preheating temperature may range from about 50° C. to about 60° C. In some embodiments, a proper preheating temperature may range from about 80° C. to about 90° C.

In some embodiments, a proper preheating viscosity may range from about 25 cP (centipoise) to about 200 cP. In some embodiments, a proper preheating viscosity may range from about 50 cP to about 125 cP. In some embodiments, a proper preheating viscosity may range from about 80 cP to about 90 cP.

In some embodiments, a proper preheating temperature and/or preheating viscosity can be predetermined following an initial analysis of the commercial wastewater 2 upon receipt and based on the constituents and/or grade of the commercial wastewater 2 analyzed.

Once the preheated wastewater 6a achieves the proper temperature and/or viscosity, the preheated wastewater 6a may be pumped and/or transported to a post-screening apparatus 13, one or more final heat tanks 71, 72, or both. The proper temperature and/or viscosity may vary but, in some embodiments, the proper temperature may range from 50° C. to 60° C. and/or the viscosity may range from 80 to 90 cP.

In some embodiments, the preheated wastewater 6a may be pumped and/or transported from the preheated tanks 63, 64 through a post-screener, such as a shaker screen 134 yielding a post-screened preheated wastewater 13a. The post-screening 13 is intended to remove any remaining solids prior to pretreatment 8 with a bentonite composition 82, while the wastewater 2, 4a is properly preheated. In some embodiments, the post-screening 13 is designed to remove solids smaller than or equal to the inlet shaker screening of the prescreening 4 step.

The post-screened preheated wastewater 13a and/or the preheated wastewater 6a (not post-screened) may be pumped and/or transported to one or more final heat tanks 71, 72 for pretreatment with a bentonite composition 82. By pretreatment 8, a bentonite composition 82 is added to and/or mixed with the preheated wastewater 6a (prescreened 4a, not prescreened 2, post-screened 13a or combinations thereof) in the final heat tanks 71, 72 and prior to any separation and/or flocculation steps.

Pretreating 8 of the preheated wastewater 6a (prescreened 4a, not prescreened 2, post-screened 13a or combinations thereof) with the bentonite composition 82 yields a pretreated wastewater 8a suitable for multiple steps of separation (e.g., centrifugal separation, floatation separation, or combinations thereof) and/or flocculation to yield an effluent water capable of introduction directly into a public sewage system. Without the addition of the bentonite composition 82 to the wastewater prior to separation and/or flocculation, the preheated wastewater 6a (prescreened 4a, not prescreened 2, post-screened 13a or combinations thereof) cannot be treated sufficiently to be introduced into the public sewage system and/or will be required to be hauled off-site for disposal via a land application, such as to a landfill, which may be less cost effective and/or less environmentally friendly than simply introducing to the sewage system 20.

The one or more final heat tanks 71, 72 include an agitator and a heat source as described herein with regard to the preheat tanks 73, 74. In some embodiments, the agitators of the final heat tanks 71, 72 may be the same as the agitators of the preheat tanks 61-64. In some embodiments, the agitators of the final heat tanks 71, 72 may be different than the agitators of the preheat tanks 61-64.

A proper pretreating temperature and pretreating viscosity of the preheated wastewater 6a (prescreened, not prescreened, post-screened, or combinations thereof) will vary depending upon the particular constituents (e.g., saturated or unsaturated fatty acids, polar oils, grease, contaminants, etc.) of the wastewater (and/or prescreened wastewater). In some embodiments, a proper pretreating temperature may range from about 50° C. to about 60° C. In some embodiments, a proper pretreating viscosity may range from about 80 cP to about 90 cP.

At the optimal pretreating temperature the grease readily will separate from the oil. At the optimal pretreating viscosity the water can move through the oil and coalesce with other droplets for removal during separation. If the viscosity is too high, the water is unable to move through the oil or coalesce with other droplets for removal during separation.

In some embodiments, an optimal or proper pretreating temperature and/or pretreating viscosity can be predetermined following an initial analysis of the commercial wastewater upon receipt and based on the constituents and/or grade of the commercial wastewater 2 analyzed.

In some embodiments, the pretreatment temperature is greater than the preheat temperature. In some embodiments, the pretreatment viscosity is less than the preheat viscosity.

Once the final heat tanks 71, 72 are generally full of the preheated wastewater 6a and the pretreatment temperature and/or viscosity of the preheated wastewater 6a are achieved, the bentonite composition 82 can be added to the wastewater to yield a pretreated wastewater 8a.

The bentonite composition may be an aqueous solution or a slurry including a bentonite, such as sodium bentonite, and a carrier. In some embodiments, the bentonite composition is a sodium bentonite slurry in an aqueous carrier, such as water or tap water.

The bentonite composition may include a bentonite concentration, and particularly a sodium bentonite concentration, ranging from 0.01 to 5% (by weight) of the composition. In some embodiments the bentonite concentration, and particularly a sodium bentonite concentration, may range from 0.05 to 2.5% (by weight) of the composition. In some embodiments the bentonite concentration, and particularly a sodium bentonite concentration, may range from 0.075 to 1.25% (by weight) of the composition. In some embodiments the bentonite concentration, and particularly a sodium bentonite concentration, may range from 0.1 to 0.4% (by weight) of the composition. Each of the bentonite concentration ranges are intended to be inclusive and also are intended to represent any number therein on an induvial basis. For example, a bentonite concentration ranging from 0.01 to 5% is intended to include 0.01% and 5% (i.e., inclusive) and/or is intended to represent 0.1%, 1%, 1.5%, 2%, etc. individually.

Some additional and/or optional ingredients may be included in the bentonite composition. Alternatively, in some embodiments, the bentonite composition may only consist of a bentonite such as sodium bentonite and a carrier such as water.

The bentonite composition may be added to the preheated wastewater 6a (prescreened, not prescreened, post-screened, or combinations thereof) at an initial pretreatment concentration ranging from 1-20% by volume of the final heat tank. In some embodiments the bentonite composition may be added to the preheated wastewater 6a (prescreened, not prescreened, post-screened, or combinations thereof) at an initial pretreatment concentration ranging from about 5-15% by volume of the final heat tank. In some embodiments the bentonite composition may be added to the preheated wastewater 6a (prescreened, not prescreened, post-screened, or combinations thereof) at an initial pretreatment concentration ranging from about 8-12% by volume of the final heat tank. Each of the initial pretreatment concentration ranges are intended to be inclusive and also are intended to represent any number therein on an induvial basis. For example, an initial pretreatment concentration ranging from 1 to 20% is intended to include 1% and 20% (i.e., inclusive) and/or is intended to represent any number therein individually, such as 1.1%, 2%, 2.5%, 10.3%, 17.8, etc.

It is further intended that any of the various bentonite concentrations may be combined with any of the various initial pretreatment concentrations described herein for pretreatment. For example, in some embodiments, the bentonite composition may include a bentonite concentration, and particularly a sodium bentonite concentration, ranging from 0.1 to 0.4% (by weight) of the composition and the bentonite composition may be added to the preheated wastewater 6a (prescreened, not prescreened, post-screened, or combinations thereof) at an initial pretreatment concentration ranging from 8-12% by volume of the final heat tank. In another example, in some embodiments, the bentonite composition may include a bentonite concentration, and particularly a sodium bentonite concentration, ranging from 0.01 to 5% (by weight) of the composition and the bentonite composition may be added to the preheated wastewater 6a (prescreened, not prescreened, post-screened, or combinations thereof) at an initial pretreatment concentration ranging from 1-20% by volume of the final heat tank. Various additional examples and/or combinations are possible and envisioned as useful in pretreatment of the preheated wastewater 6a (prescreened, not prescreened, post-screened, or combinations thereof).

In some embodiments, the bentonite composition, and particularly a sodium bentonite composition, is the only material added to the preheated wastewater 6a (prescreened, not prescreened, post-screened, or combinations thereof) prior to the first separation step.

Once the pretreated wastewater 8a, i.e., including the bentonite composition, and particularly a sodium bentonite composition, is formed, the pretreated wastewater 8a can be pumped and/or transported from the final heat tanks 71, 72, to one or more first centrifugal separators 101, 102, such as a tricanter(s), for a first centrifugal separation 10 into three phases, i.e., a solids stream 5, an oil-based stream 9, and a water-based stream 11.

The first centrifugal separation step 10 is designed to concentrate the grease in the wastewater by using centrifugal force to separate at least the polar oils from the water and any impurities. The one or more centrifugal separators 101, 102 separate the pretreated wastewater 8a into a water-based stream 11, an oil-based stream 9, and a solids stream 5.

The oil-based stream 9 including the concentrated grease is discharged from the tri-phase centrifugal separator(s) 101, 102, i.e., tricanter(s), into one or more oil surge tanks 92 for collection. When the surge tank(s) 92 reaches an operating level, a transfer pump is activated and the heated oil-based stream 9 including concentrated grease is transferred to one or more ISO product (Finished Oil) storage tanks 94. From there, the oil-based stream 9 can be loaded onto tanker trucks or rail cars for delivery off site. In some embodiments, the oil-based stream 9 may be recycled into a feedstock for biofuel and/or biodiesel generation.

The water based stream 11 may be pumped and/or transported to one or more stick water storage tanks 112 prior to being flocculated. The water-based stream 11 maintains a reduced second concentration of bentonite and/or bentonite composition 82 after the first centrifugal separation 10. Although reduced, the second concentration of bentonite and/or bentonite composition 82 of the water-based stream 11 is maintained at a level sufficient to be useful in separating out additional polar FOG materials and/or contaminants in at least a second centrifugal separation 14 process. For example, in some embodiments, an initial concentration of bentonite and/or bentonite composition 82 may be reduced by about 25-75% after the first centrifugal separation step 10 and/or in the water-based stream 11. In some embodiments, the reduction may range from about 30-50%. In some embodiments, the reduction may range from 35-45%.

From the stick water storage tank 112, the water-based stream 11 including a reduced second concentration of bentonite (and/or bentonite composition 82) is flocculated for a first time 12. The first flocculation 12 includes adjusting the pH of the water-based stream 11 inline to 7.0+/−1 via the addition of one or more pH adjusters 122, such as a base additive. One non-limiting example of a suitable pH adjuster includes sodium hydroxide. Immediately following the pH adjustment, one or more cationic polymers 124 are injected into the generally neutralized water-based stream 11 inside a first set of flocculation tubes 121. The flocculation tubes 121 allow for the pH adjusted, coagulated water-based stream 11 to begin and complete the process of flocculation 12 yielding a flocculated first water-based stream 12a including one or more first flocculent materials suspended therein.

The flocculated first water-based stream 12a then flows to a second centrifugal separator 142, such as a decanter (e.g., vertical decanter, horizontal decanter, conveyor decanter), for separation into two phases, and more particularly, further separation of solids 5 from the water-based stream 11. The second centrifugal separator 142 discharges a solid phase 14b collected into a hopper or bin 5 for further solids disposal or recycling off-site and a second water-based stream 14a. The second water-based stream 14a is flocculated for a second time 16. The second flocculation 16 includes maintaining or adjusting the pH of the second water-based stream 14a inline to 7.0+/−1 via the addition of one or more pH adjusters 162, such as a base or acidic additive. Immediately following the pH adjustment, one or more coagulants 164 (e.g., a cationic polymer) are injected into the generally neutralized second water-based stream 14a inside a second set of flocculation tubes 161. The flocculation tubes 161 allow for the pH adjusted, coagulated second water-based stream 14a to begin and complete the process of flocculation 16 yielding a flocculated second water-based stream 16a including one or more second flocculent materials suspended therein.

The flocculated second water-based stream 16a then flows to a floatation separator 182, such as a Dissolved Air Flotation (DAF) unit, for additional separation and/or removal of any remaining solid FOG materials and/or flocculent materials to yield a third water-based stream 18a. The DAF unit 182 uses the buoyancy of gas to lift FOG materials contained in the flocculated second water-based stream 16a to the surface. The natural tendency of the FOG materials and/or any remaining suspended solids is to float, so the DAF unit 182 will merely increase the efficiency of the natural tendency. The DAF unit 182 employs a pressurization system to saturate the flocculated second water-based stream 16a with air at an elevated pressure. The pressurized flocculated second water-based stream 16a is then introduced into the DAF unit through a pressure reducing device. The sudden drop in pressure causes the release of microbubbles from the supersaturated stream that rise to the surface. The floating FOG materials are then skimmed from the DAF unit 182 and recovered for further processing in the second centrifugal separator, i.e., decanter 142. The third water-based stream 18a can be pumped and/or flow into one or more effluent storage tanks 19 prior to being discharged to the POTW 20.

The third water-based stream 18a may include less than 0.1% (by volume) bentonite and/or bentonite composition, and particularly less than 0.1% sodium bentonite. The third water-based stream 18a may include less than 100 mg/L polar FOG materials and thus suitable for introduction into the POTW without risk of damaging the physical structure (pipes, drains, valves, etc.) of the POTW and/or within the acceptable chemical limits necessitated by the EPA and/or any other legally applicable government agency. The third water-based stream 18a being of sufficient purity and/or treatment to avoid having to be shipped off-site to a landfill or further processing facility.

In some embodiments, the system 1, 100 for treating and/or purifying commercial wastewater may include one or more of the following components, a screening apparatus 4 (e.g., static debris screener 42, shaker screener 44, etc.), a preheating tank(s) 61, 62, 63, 64 (with or without agitation), a pretreating final heating tank(s) 71, 72, a tricanter(s) 101, 102, a flocculator(s) 122, 161, a decanter(s) 142, a stick tank(s) 112, an ISO oil tank(s) 94, an effluent tank(s) 19, a solids storage bin(s) 5, a scrubber system, a heating (e.g., steam) system, or any combination thereof.

As provided throughout FIG. 2, a solids stream 5 is produced and/or separated from the wastewater at various steps (e.g., prescreening 4, post-screening 13, first centrifugal separation 10, second centrifugal separation 14, floatation separation 18) of the methods and/or systems 1, 100 described herein. Although shown schematically as a single collection bin or tank, it is envisioned that the solid stream 5 may be further separated based on a variety of differentiating characteristics between the solids, such as separating recyclable solids for non-recyclable solids.

As further provided throughout FIG. 2, at various steps (e.g., prescreening 4, preheating 6, pretreating 8, post-screening 13, first centrifugal separation 10, second centrifugal separation 14, floatation separation 18) of the methods and/or systems 1, 100 described herein, heat (designated as an “*”) may be applied and/or added. Any suitable method of providing heat is envisioned. In some embodiments, the methods and/or systems include a separate heating system which produces heat and transports the heat to various parts and/or steps of the methods and/or systems 1, 100. In some embodiments, each step of the methods and/or components of the system include their own individual heating system. Some non-limiting examples of suitable heating systems include steam heating systems, hot air heating systems, and the like. In some embodiments, the heating system includes a separate steam generator interconnected to the various components and/or steps of the systems and/or methods described herein.

As still further provided throughout FIG. 2, at various steps (e.g., preheating 6, pretreating 8, water-based stream collection 11, 19) of the methods and/or systems 1, 100 described herein, odor control (designated as an “\hat{ }”) may be applied and/or added. Any suitable method of providing odor control is envisioned. In some embodiments, the methods and/or systems include a separate scrubber system which controls and/or removes any odors resulting from the processing of the various wastewaters described herein.

It will be understood that various modifications may be made to the embodiments of the presently disclosed methods and/or systems. Therefore, the above description should not be construed as limiting, but merely as exemplifications of embodiments. Those skilled in the art will envision other modifications within the scope and spirit of the present disclosure.

What is claimed is:

1. A method of treating commercial wastewater containing polar oils comprising:
pretreating an amount of commercial wastewater with a bentonite composition in one or more final heat tanks yielding a pretreated wastewater,
separating the pretreated wastewater, via a first centrifugal separator, into at least an oil-based stream and a first water-based stream,
flocculating the first water-based stream yielding a flocculated first water-based stream,
separating at least flocculent, via a second centrifugal separator, from the flocculated first water-based stream yielding a second water-based stream,
flocculating the second water-based stream yielding a flocculated second water-based stream,
separating at least flocculent, via a floatation separator, from the flocculated second water-based stream yielding a third water-based stream of sufficient treatment configured to be discharged directly to a public sewage treatment plant (POTW).

2. The method of claim 1, further comprising prescreening the commercial wastewater prior to pretreating.

3. The method of claim 2, wherein prescreening comprises passing the commercial wastewater through a debris screening configured to remove large solids greater than about 0.25 inches, a classifying shaker screen configured to remove small solids less than about 0.25 inches, or both.

4. The method of claim 2, further comprising adding steam to the commercial wastewater prior to prescreening.

5. The method of claim 1, further comprising preheating the commercial wastewater in one or more preheat tanks prior to pretreating yielding a preheated wastewater.

6. The method of claim 5, wherein the preheated wastewater is preheated to a first temperature ranging from about 50° C. to about 60° C.

7. The method of claim 5, wherein a viscosity of the preheated wastewater ranges from about 80 cP to about 90 cP.

8. The method of claim 5, further comprising agitating the commercial wastewater during preheating inside at least one of the one or more preheat tanks.

9. The method of claim 1, further comprising agitating the commercial wastewater during pretreating inside the one or more final heat tanks.

10. The method of claim 6, wherein the preheated wastewater is heated to an optimal pretreating temperature ranging from about 80° C. and about 90° C. prior to pretreating in the one or more final heat tanks.

11. The method of claim 6, wherein an optimal pretreating viscosity of the preheated wastewater ranges from 80 cP to 90 cP prior to pretreating in the one or more final heat tanks.

12. The method of claim 1, wherein the bentonite composition comprises a sodium bentonite slurry.

13. The method of claim 12, wherein the sodium bentonite represents from about 0.01% to about 5% by weight of the bentonite slurry.

14. The method of claim 12, wherein the sodium bentonite represents from about 0.1% to about 0.4% by weight of the bentonite slurry.

15. The method of claim 12, wherein the preheated wastewater is pretreated with about 1% to about 20% bentonite slurry by volume.

16. The method of claim 12, wherein the preheated wastewater is pretreated with about 8% to about 12% bentonite slurry by volume.

17. The method of claim 1, wherein the first centrifugal separator includes one or more tricanters and the second centrifugal separator includes one or more decanters.

18. The method of claim 1, wherein the floatation separator includes a DAF unit.

19. The method of claim 1, wherein the oil-based stream is separately collected in one or more ISO tanks.

20. A system for treating commercial wastewater comprising:
a prescreening apparatus,
a preheating tank configured to receive and preheat an amount of the commercial wastewater therein to yield a preheated wastewater,
a final heating tank configured to receive and heat the preheated wastewater and mix the preheated wastewater with a bentonite composition thereinto yield a pretreated wastewater containing bentonite,
a first centrifugal separator configured to separate the pretreated wastewater into a first water-based stream, an oil-based stream, and a solid stream,
a first flocculator configured to flocculate the first water-based stream to yield a flocculated first water-based stream,
a second centrifugal separator configured to separate the flocculated first water-based stream to yield a second water-based stream,
a second flocculator configured to flocculate the second water-based stream to yield a flocculated second water-based stream, and
a floatation separator configured to separate the second water-based stream to yield a third water-based stream of sufficient treatment for discharge directly to a public sewage treatment plant (POTW).
